(19) United States
(12) Patent Application Publication
(10) Pub. No.: US 2025/0253583 A1
(43) Pub. Date: Aug. 7, 2025

(54) CONNECTORS WITH PIEZOCHROMIC MATERIAL FOR INDICATING INTERFACE OF CONNECTOR ENDS AND RELATED METHODS

(71) Applicant: Lenovo Global Technology (United States) Inc., Morrisville, NC (US)

(72) Inventors: Grason Humphrey, Morrisville, NC (US); Eric Li, Morrisville, NC (US); Milton Cobo, Morrisville, NC (US); Michael DeCesaris, Morrisville, NC (US)

(21) Appl. No.: 18/429,534

(22) Filed: Feb. 1, 2024

(51) Int. Cl. H01R 13/641; G02F 1/17

(52) U.S. Cl. CPC H01R 13/641; G02F 1/178

(57) ABSTRACT

Connectors with piezochromic material for indicating interface of connector ends and related methods are disclosed. According to an aspect, a connector includes a connector end that defines an interior space for containing a piezochromic material. The connector end is configured to interface with another connector end. The connector also includes a window integrated into the connector end to provide view from outside of the connector end to the interior space. Further, the connector includes a moveable component integrated with the connector end and moveable, by interface of the connector end with the other connector end, in a direction to decrease a volume of the interior space for compressing the piezochromic material contained in the interior space such that the piezochromic material changes color for indicating interface of the connector end with the other connector end.

### TECHNICAL FIELD

The presently disclosed subject matter relates generally to connectors. Particularly, the presently disclosed subject matter relates to connectors with piezochromic material for indicating interface of connector ends.

### BACKGROUND

Servers and other computing devices have cables for operative connection to power sources, network equipment, or other electrical equipment. A cable may have a connector end for attaching to a computing device's connector end. When the connector ends are properly attached, the computing device can receive power or exchange data with other electrical equipment attached to an opposing end of the cable. Therefore, it is important that the connector ends are properly connected to ensure these functionalities.

In the case of a server, as size and complexity increases, a frequent problem encountered when assembly or modifying servers is the improper connection of a cable's connector end to the server's connector end. Since servers can have a multitude of cable ends, there are many opportunities for a cable to be impartially connected such that it appears to be correctly connected but is actually not making electrical contact needed for operation. This improper connection may be extremely difficult to discover since the connection may appear to be proper, often requiring extensive debug time to determine and fix the problem.

Presently, there are some indicators for proper connection of connector ends. Such indicators provide auditory and tactile feedback; however, these techniques present accessibility issues since they cannot be detected easily or by individuals with difficulty perceiving such feedback. In view of these challenges, there is a need for improved techniques for indicating proper connection of connector ends.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1A is a side view of a cable connector with piezochromic material for indicating interface of its connector end with another connector end in accordance with embodiments of the present disclosure;

FIG. 1B is a side view of the connector end of the cable shown in FIG. 1A having proper interface with the connector end of the computing device;

FIG. 1C is a close, cross-sectional side view of the space of the connector end that contains an interior space, a window, and a flexible diaphragm;

FIG. 1D is another close, cross-sectional side view of the space of the connector end as shown in FIG. 1C with the diaphragm moved upward by a protrusion for compressing piezochromic material;

FIG. 1E is a top view of the connector end shown in FIGS. 1A-1D;

FIG. 1F is a top view of the connector end shown in FIGS. 1A-1D;

FIG. 2 is a flow diagram of a method for indicating interface of connector ends in accordance with embodiments of the present disclosure;

FIG. 3A is a side view of an expansion card having a connector end with piezochromic material for indicating interface of the connector end with a connector end of a computing device in accordance with embodiments of the present disclosure;

FIG. 3B is a side view of the connector end of the expansion card shown in FIG. 3A having proper interface with the connector end of the computing device;

FIG. 4A is a cross-sectional, side view of a portion of a connector end with a covering that is moveable by a protrusion for indicating interface of the connector end with another connector end in accordance with embodiments of the present disclosure;

FIG. 4B is a cross-sectional, side view of the connector end that is the same as FIG. 4A except with a protrusion having moved the covering;

FIG. 5A is a cross-sectional, side view of a portion of connector ends having piezochromic material for indicating interface of the connector end with the other connector end in accordance with embodiments of the present disclosure; and

FIG. 5B illustrates a cross-sectional, side view of the view of the portion of connector ends shown in FIG. 5A with the moveable component compressing the piezochromic material by force applied by the protrusion.

### SUMMARY

The presently disclosed subject matter relates to connectors with piezochromic material for indicating interface of connector ends and related methods. According to an aspect, a connector includes a connector end that defines an interior space for containing a piezochromic material. The connector end is configured to interface with another connector end. The connector also includes a window integrated into the connector end to provide view from outside of the connector end to the interior space. Further, the connector includes a moveable component integrated with the connector end and moveable, by interface of the connector end with the other connector end, in a direction to decrease a volume of the interior space for compressing the piezochromic material contained in the interior space such that the piezochromic material changes color for indicating interface of the connector end with the other connector end.

According to another aspect, a method includes providing a connector including a connector end that defines an interior space for containing a piezochromic material. The connector end is configured to interface with another connector end. Further, the connector includes a window integrated into the connector end to provide view from outside of the connector end to the interior space. The connector also includes a moveable component integrated with the connector end and moveable by interface of the connector end with the other connector end. The method further includes moving the moveable component in a direction to decrease a volume of the interior space for compressing the piezochromic material contained in the interior space such that the piezochromic material changes color for indicating interface of the connector end with the other connector end.

According to another aspect, a connector includes a connector end that defines passageway that extends between a first opening and a second opening. The connector also includes a covering that at least partially covers the first opening. Further, the connector includes an interface side that is configured to interface with another connector end having a protrusion, wherein the second opening is position on the interface side. The protrusion extends through the second opening, through the passageway, and through the second opening such that the covering is moved for view of the protrusion for indicating interface of the connector end with the other connector end.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

“About” is used to provide flexibility to a numerical endpoint by providing that a given value may be “slightly above” or “slightly below” the endpoint without affecting the desired result.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Recitation of ranges of values herein are merely intended to serve as a shorthand method of referring individually to each separate value falling within the range, unless otherwise indicated herein, and each separate value is incorporated into the specification as if it were individually recited herein. For example, if a range is stated as between 1%-50%, it is intended that values such as between 2%-40%, 10%-30%, or 1%-3%, etc. are expressly enumerated in this specification. These are only examples of what is specifically intended, and all possible combinations of numerical values between and including the lowest value and the highest value enumerated are to be considered to be expressly stated in this disclosure.

Unless otherwise defined, all technical terms used herein have the same meaning as commonly understood by one of ordinary skill in the art to which this disclosure belongs.

As referred to herein, the term “piezochromic material” refers to a material having the characteristic of changing color with application or pressure. Example piezochromic material includes, but is not limited to, piezochromic ink, piezochromic liquid, and piezochromic plastic.

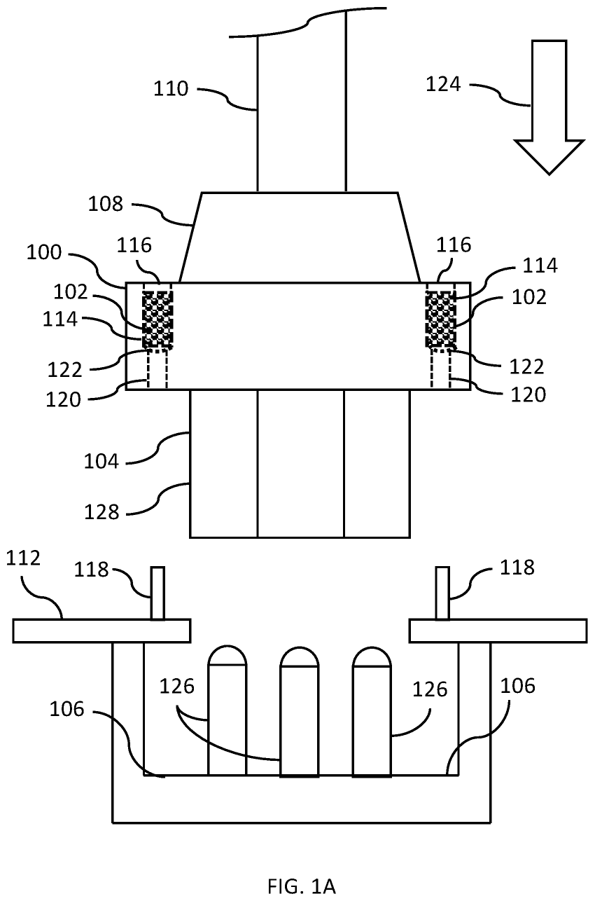

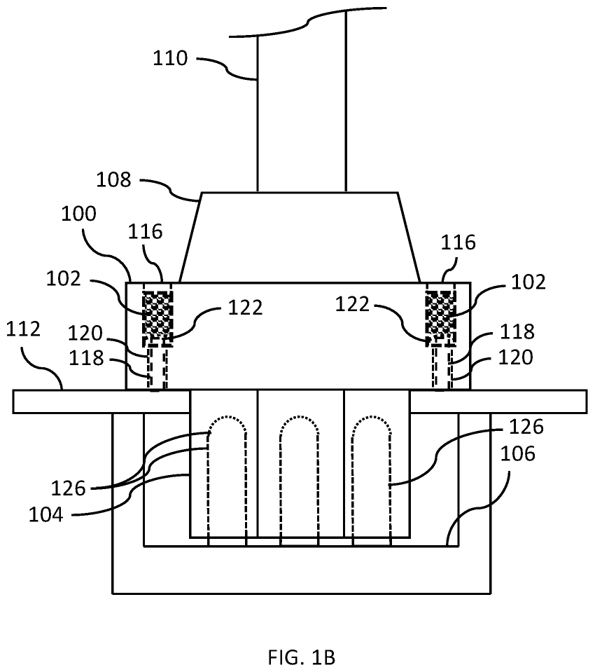

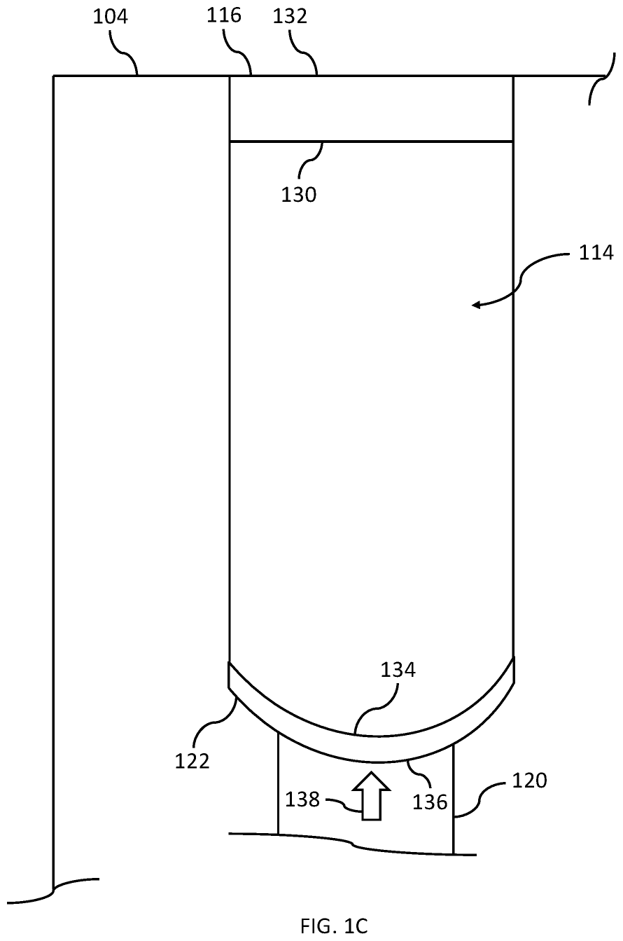

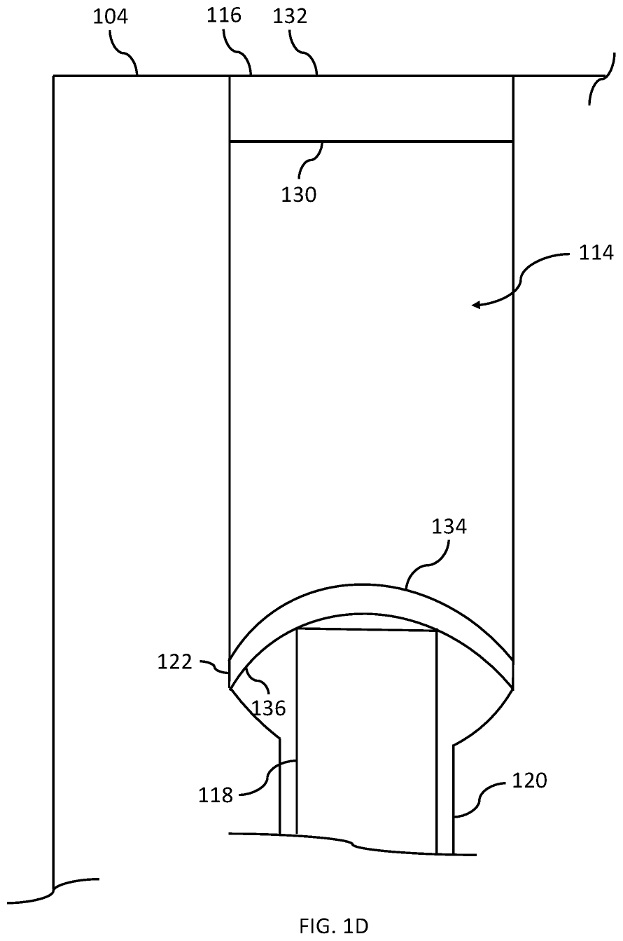

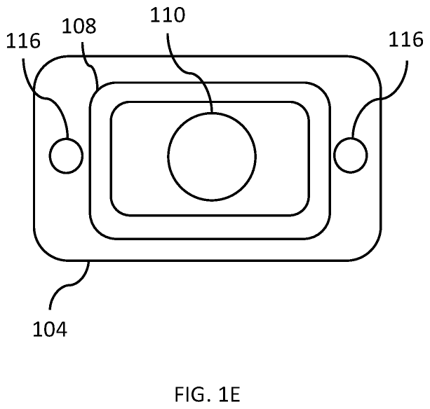

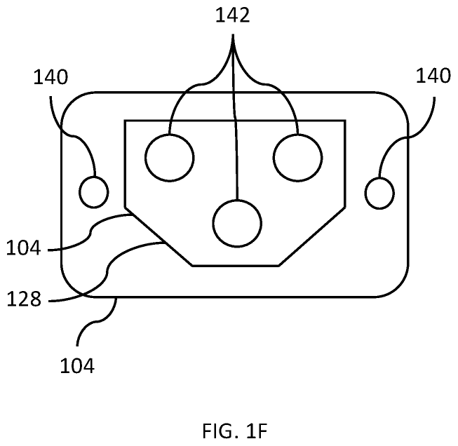

FIG. 1A illustrates a side view of a cable connector 100 with piezochromic material 102 for indicating interface of its connector end 104 with another connector end 106 in accordance with embodiments of the present disclosure. Referring to FIG. 1A, the connector end 104 is operatively connected to an end 108 of a power cable 110. In this example, the power cable 110 can be connected to a power source for delivery of electrical power to a computing device 112. In this example, the computing device 112 is a server and only a portion that interfaces a power cable for receipt of electrical power is shown for convenience of illustration.

With continuing reference to FIG. 1A, piezochromic material 102 is located in two (2) interior spaces 114 defined by the connector end 104. The interior spaces 114 may have one or more walls surrounding the piezochromic material 102. In this example, transparent or semi-transparent windows 116 can be at ends of the interior spaces 114 for closing those ends and for providing view of the piezochromic material 102 by an operator. As will be described in more detail herein, the operator can view a color or change in color of the piezochromic material 102 by looking into the windows 116 to thereby determine whether the connector end 104 is properly connected to the connector end 106 of the computing device 112. Example material for the windows 116 include, but is not limited to, plastic, latex, glass, mylar, polystyrene, vinyl, or combinations thereof.

The connector end 106 of the computing device 112 includes protrusions 118 that extend in a direction for interface with the connector end 104 of the power cable 110. The protrusions 118 are positioned such that they can fit into respective passageways 120 defined in the connector end 104. Particularly, the protrusions 118 can fit into respective passageways 120 when the connector end 104 is moved in a direction indicated by arrow 124 for interface of the connector end 104 with the connector end 106. At the end of each passageway 120 is located a flexible diaphragm or other moveable component 122 that can be pushed by a respective protrusion 118 in a direction of the piezochromic material 102 when the connector ends 104 and 106 are being properly interfaced. When the flexible diaphragms 122 are being pushed upward, then an opposing side of the flexible diaphragms 122 can compress the piezochromic material 102 such that it changes color to indicate proper interface of the connector ends 104 and 106. The flexible diaphragms 122 can sealingly enclose the piezochromic material 102 in their respective interior spaces 114. Example materials for the diaphragms 122 include, but are not limited to, plastic, latex, mylar, polystyrene, vinyl, rubber, silicone, nitrile, neoprene.

Passageways 120 can be any suitable size or shape for receipt of protrusions 118. Also, protrusions 118 can be any suitable size or shape such that they contact and move diaphragms 122 for compressing the piezochromic material 102. For example, passageways 120 and diaphragms 122 may be cylindrical in shape. In addition, there may be any suitable number of passageways, diaphragms and other components in accordance with embodiments of the present disclosure.

Connector end 106 includes several conductive prongs 126 for operatively interfacing with corresponding contacts (not shown) within a portion 128 of the connector end 104. When properly the connector ends 104 and 106 are properly interfaced, the prongs 126 and internal contacts of portion 128 are conductively connected such that electrical power can pass from the power cable 110 to the computing device 112.

FIG. 1B illustrates a side view of the connector end 104 of the cable 110 shown in FIG. 1A having proper interface with the connector end 106 of the computing device 112. Referring to FIG. 1B, the figure shows the connector end 104 positioned such that it is fully and operatively connected to the connector 106. Particularly, it is operatively connected in that prongs 126 are electrically contacting the contacts (not shown) within the portion 128 of the connector end 104. Also, in this position the protrusions 118 fit into their respective passageways 120 to an extent such that the protrusions 118 push on their respective diaphragms 122. As a result, the diaphragms 122 move to compress the piezochromic material 102 such that the piezochromic material 102 changes color to indicate proper interface with the connector end 106 of the computing device 112. An operator viewing the piezochromic material 102 through windows 116 can see the color change through the windows 116 and thereby recognize that proper interface of connector ends 104 and 106.

FIG. 1C illustrates a close, cross-sectional side view of the space of the connector end 104 that contains an interior space 114, a window 116, and a flexible diaphragm 122. Referring to FIG. 1C, the interior space 114 can be defined at one side by a surface 130 of the window 116. The window 116 has a surface 132 that opposes surface 132, which is on an outside of the connector end 104 such that the operator can view into the interior space 114.

With continuing reference to FIG. 1C, the side of the interior space 114 that opposes the side of the window 116 can be defined by a side 134 of the diaphragm 122. The diaphragm 122 has a surface 136 that opposes the surface 134. A force applied to the surface 136 in the direction indicated by arrow 138, such as by a protrusion as described by example herein, can move the diaphragm 122 in the same direction to thereby compress piezochromic material (not shown in FIG. 1C) contained herein to change the piezochromic material's color as described herein.

FIG. 1D illustrates another close, cross-sectional side view of the space of the connector end 104 as shown in FIG. 1C with the diaphragm 122 moved upward by a protrusion 118 for compressing piezochromic material. Referring to FIG. 1D, the protrusion 118 is pressed against the side 136 of the diaphragm 122 such that the diaphragm 122 is deflected upwards. As a result, the piezochromic material can be compressed to change color for indicating proper interface of the connector ends.

FIG. 1E illustrates a top view of the connector end 104 shown in FIGS. 1A-1D. Referring to FIG. 1E, windows 116 are positioned on opposing sides of the cord 110. This can be beneficial, for example, because different sides of the connector end 104 can have the piezochromic material that can be viewed to ascertain whether both sides of the connector end 104 are interfaced to another connector end, such as connector end 106.

FIG. 1F illustrates a top view of the connector end 104 shown in FIGS. 1A-1D. Referring to FIG. 1F, the connector end 104 defines apertures or openings 140 for the passageways 120 shown in FIGS. 1A and 1B. In addition, the connector end 104 defines apertures or openings 142 for receipt of prongs 126.

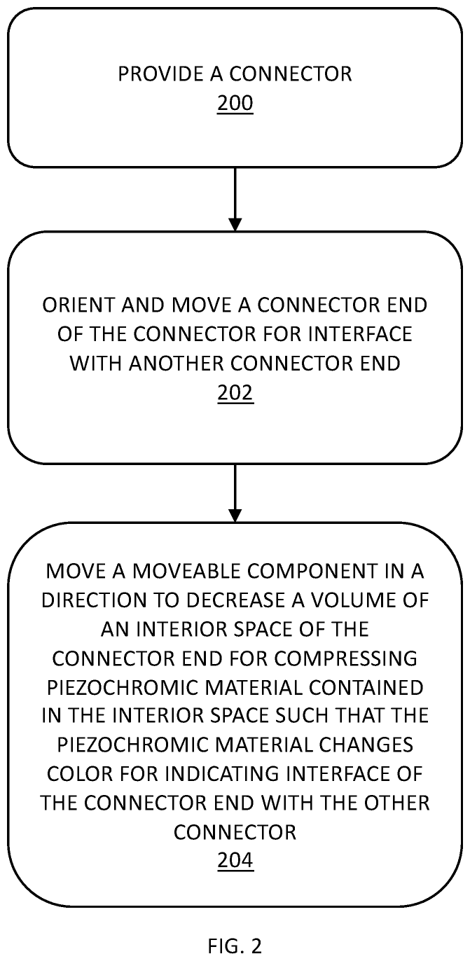

FIG. 2 illustrates a flow diagram of a method for indicating interface of connector ends in accordance with embodiments of the present disclosure. It is noted that this method is described as being implemented by the connectors 104 and 106 shown I FIGS. 1A-1F, although it should be understood that the method may be implemented by any suitable set of connector ends. Referring to FIG. 2, the method includes providing 200 a connector, such as the cable connector 100 shown in FIGS. 1A-1F.

The method of FIG. 2 also includes orienting and moving 202 a connector end of the connector for interface with another connector end. Continuing the aforementioned example, FIG. 1A shows connector end 104 aligned with connector end 106. With the shown alignment, the connector end 104 is positioned for movement to interface with the connector end 106. Subsequently, the connector end 104 can be moved in the direction of arrow 124 to interface with connector end 106.

The method of FIG. 2 includes moving 204 a moveable component in a direction to decrease a volume of an interior space of the connector end for compressing piezochromic material contained in the interior space such that the piezochromic material changes color for indicating interface of the connector end with the other connector end. Continuing the aforementioned example, the connector end 104 is moved from the position shown in FIG. 1A to the position shown in FIG. 1B such that the protrusions 118 push the flexible diaphragms 122 in a direction to compress the piezochromic material 102 for effecting the piezochromic material's 102 color change. This change of color can then be viewed through the windows 116.

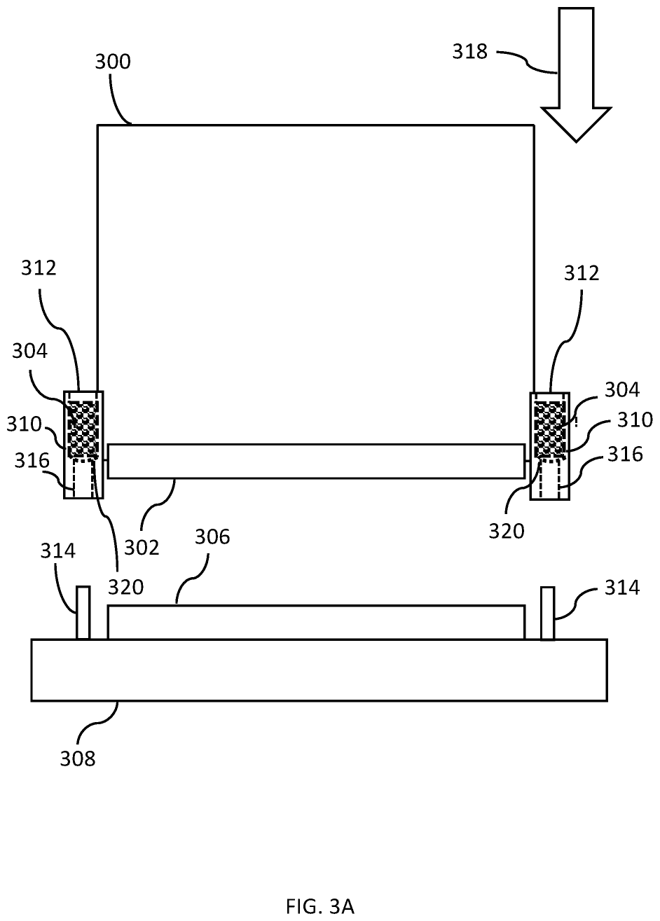

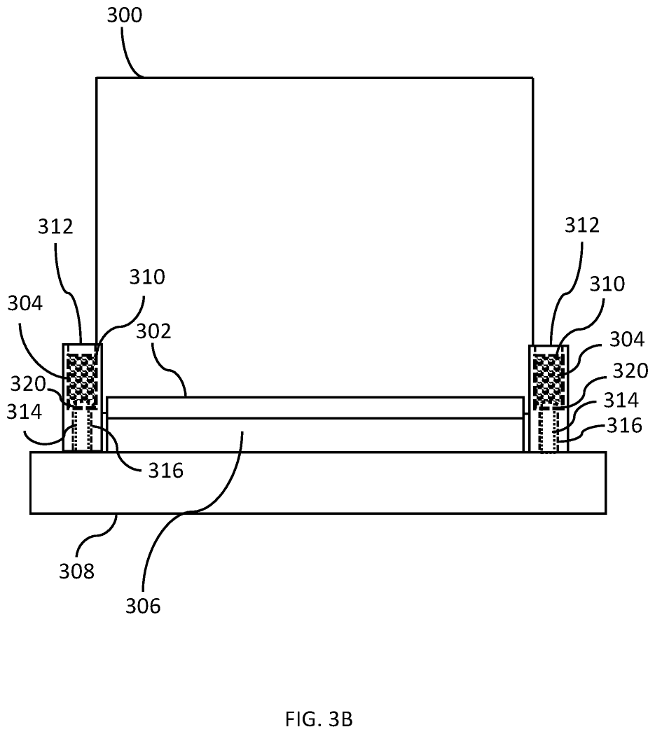

FIG. 3A illustrates a side view of an expansion card 300 having a connector end 302 with piezochromic material 304 for indicating interface of the connector end 302 with a connector end 306 of a computing device 308 in accordance with embodiments of the present disclosure. Referring to FIG. 3A, the connector end 302 can include an edge connector 308 that is operatively connected to circuitry (e.g., hardware; not shown) of the expansion card 300. The connector end 306 can be a socket of the computing device 308. It is noted that, for convenience of illustration, only a portion of the computing device 308 is shown. The computing device 308 may be a server, desktop computer, or the like. Example expansion cards include, but are not limited to, a memory card, a network card, a graphics card, a sound card, and the like.

With continuing reference to FIG. 3A, piezochromic material 304 is located in two (2) interior spaces 310 defined by the connector end 302. The interior spaces 310 may have one or more walls surrounding the piezochromic material 304. In this example, transparent or semi-transparent windows 312 can be at ends of the interior spaces 310 for closing those ends and for providing view of the piezochromic material 304 by an operator. The operator can view a color or change in color of the piezochromic material 304 by looking into the windows 312 to thereby determine whether the connector end 304 is properly connected to the connector end 302 of the computing device 308.

The connector end 306 of the computing device 308 includes protrusions 314 or the protrusions 314 are attached to the connector end 306. The protrusions 314 can extend in a direction for interface with the connector end 302 of the expansion card 300. The protrusions 314 are positioned such that they can fit into respective passageways 316 defined in the connector end 302. Particularly, the protrusions 314 can fit into respective passageways 316 when the connector end 302 is moved in a direction indicated by arrow 318 for interface of the connector end 302 with the connector end 306. At the end of each passageway 316 is located a flexible diaphragm or other moveable component 320 that can be pushed by a respective protrusion 314 in a direction of the piezochromic material 304 when the connector ends 302 and 306 are being properly interfaced. When the flexible diaphragms 320 are being pushed upward, then an opposing side of the flexible diaphragms 320 can compress the piezochromic material 304 such that it changes color to indicate proper interface of the connector ends 302 and 306. The flexible diaphragms 320 can sealingly enclose the piezochromic material 304 in their respective interior spaces 310.

FIG. 3B illustrates a side view of the connector end 302 of the expansion card 300 shown in FIG. 3A having proper interface with the connector end 306 of the computing device 308. Referring to FIG. 3B, the figure shows the connector end 302 positioned such that it is fully and operatively connected to the connector 306. Particularly, it is operatively connected in that the edge connector 308 is electrically connected to the contacts (not shown) within the connector end 306 (or socket in this example). Also, in this position the protrusions 118 fit into their respective passageways 120 to an extent such that the protrusions 314 push on their respective diaphragms 320. As a result, the diaphragms 320 move to compress the piezochromic material 304 such that the piezochromic material 304 changes color to indicate proper interface with the connector end 306 of the computing device 308. An operator viewing the piezochromic material 304 through windows 312 can see the color change through the windows 312 and thereby recognize that proper interface of connector ends 302 and 306.

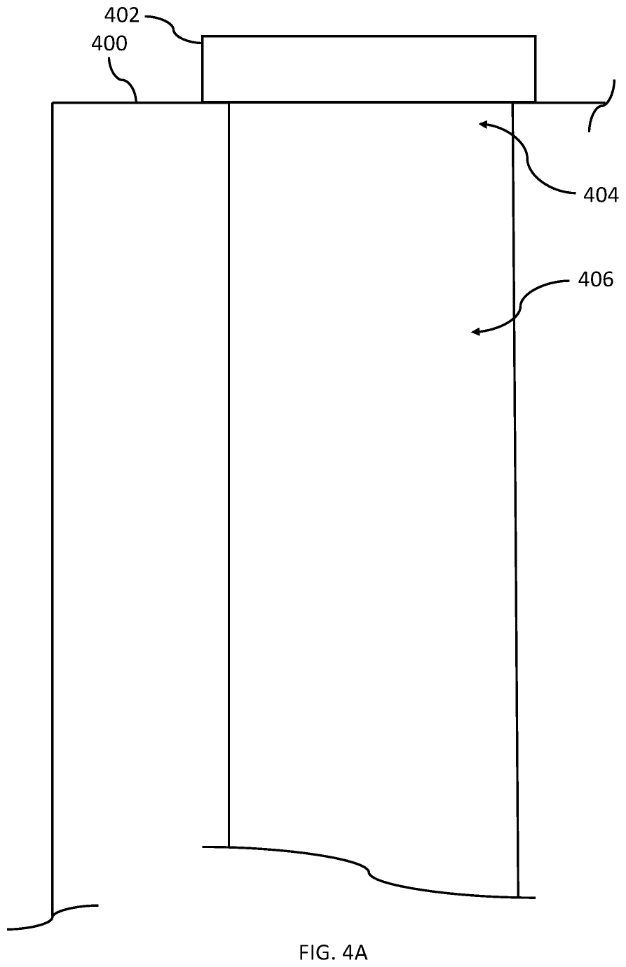

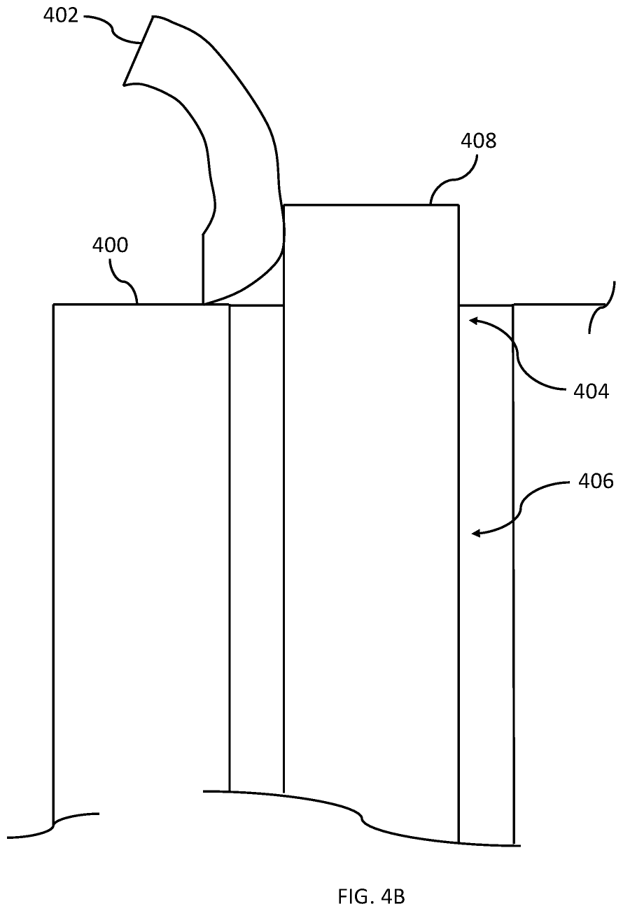

FIG. 4A illustrates a cross-sectional, side view of a portion of a connector end 400 with a covering 402 that is moveable by a protrusion for indicating interface of the connector end 400 with another connector end (not shown) in accordance with embodiments of the present disclosure. The portion of the connector end 400 shown in FIG. 4A can be the same as the portion of the connector end 104 shown in FIG. 1C, but replacing the features and parts shown there with the features and parts shown in FIG. 4A. Referring to FIG. 4A, the covering 402 can cover an opening (generally designated with reference 404) for a passageway (generally designated with reference 406). The passageway 406 extends from the opening 404 at one end to an opposing end similar to the other end of a passageway 120 shown in FIG. 1A.

With continuing reference to FIG. 4A, a protrusion (not shown in FIG. 4A) attached to another connector end can extend upward through the passageway 120 similar to the protrusion 118 shown in FIG. 1A. One difference with the protrusion in this embodiment is that it is longer so that it moves the covering 402 such that the protrusion can be viewed by a user when the connector end 400 is properly connected to the other connector end. For example, FIG. 4B illustrates a cross-sectional, side view of the connector end 400 that is the same as FIG. 4A except with a protrusion 408 having moved the covering 402. In FIG. 4B, the protrusion 408 can be visible to an operator for indicating proper connector end attachment.

The covering 402 can be made of a flexible material for deflection when pushed by the protrusion 408 as described herein. An example material for the covering 402 is rubber or plastic. In an example, the covering 402 can be attached on one side to the connector end 400. When pushed by the protrusion 408 as shown in FIG. 4B, the flexible characteristic allows the protrusion 408 to be deflected as shown. When the protrusion is withdrawn, the covering 402 can return to its position for covering the opening 404 as shown in FIG. 4A. Alternatively, the covering 402 may only partially cover the opening 404.

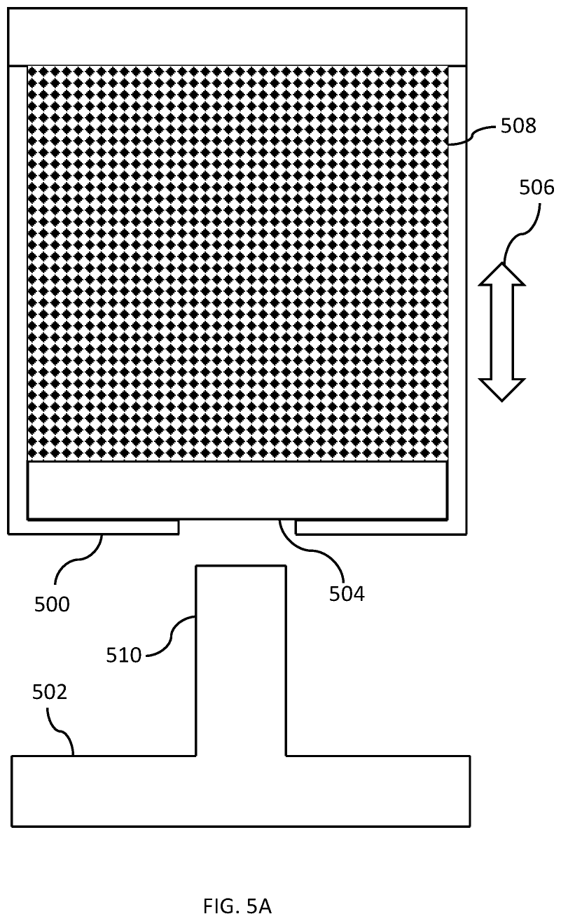

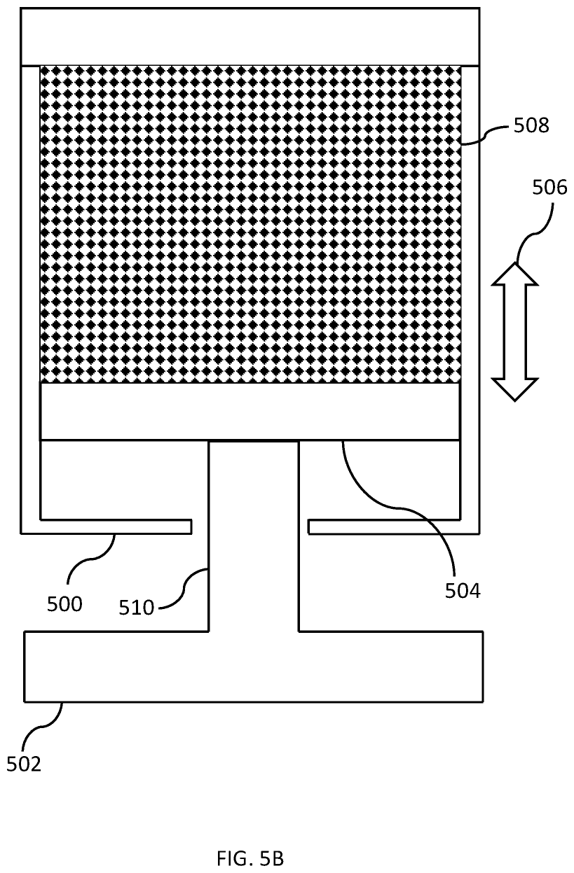

FIG. 5A illustrates a cross-sectional, side view of a portion of connector ends 500 and 502 having piezochromic material for indicating interface of the connector end 500 with the other connector end 502 in accordance with embodiments of the present disclosure. Referring to FIG. 5A, the connector end 500 includes a moveable component (or plunger) 504 configured to move in the directions indicated by double arrow 506 (i.e., an upward direction and a downward direction as oriented in the figure). The moveable component 504 can be moved in the directions 506 within an interior space 508 of the connector end 500. Example materials for the moveable component 504 include, but are not limited to, plastic, glass, metal, the like, or combinations thereof.

With continuing reference to FIG. 5A, the connector end 502 can include a protrusion 510 for engaging and pushing the moveable component 504 upward. As a result of moving the moveable component 504 upward, piezochromic material 512 in the interior space 508 can be compressed to thereby change color as described by example herein. The color changed can be observed through a window 514 as described by example herein. FIG. 5B illustrates a cross-sectional, side view of the view of the portion of connector ends 500 and 502 shown in FIG. 5A with the moveable component 504 compressing the piezochromic material 512 by force applied by the protrusion 510.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed is:

1. A connector comprising:
a connector end that defines an interior space for containing a piezochromic material, the connector end being configured to interface with another connector end;
a window integrated into the connector end to provide view from outside of the connector end to the interior space; and
a moveable component integrated with the connector end and moveable, by interface of the connector end with the other connector end, in a direction to decrease a volume of the interior space for compressing the piezochromic material contained in the interior space such that the piezochromic material changes color for indicating interface of the connector end with the other connector end.

2. The connector of claim 1, wherein the connector end is a connector end of an electrical cable.

3. The connector of claim 1, wherein the piezochromic material includes one of piezochromic ink, piezochromic liquid, or piezochromic plastic.

4. The connector of claim 1, wherein the other connector end defines a protrusion that moves the moveable component in the direction to decrease the volume of the interior space when the connector end and/or the other connector end are moved to a position such that the connector end and the other connector end interface.

5. The connector of claim 1, wherein the moveable component is a flexible diaphragm configured to deflect in the direction of the interior space to decrease the volume of the interior space for compressing the piezochromic material.

6. The connector of claim 5, wherein the other connector end defines a protrusion that engages and pushes the flexible diaphragm to deflect in the direction of the interior space when the connector end and/or the other connector end are moved to a position such that the connector end and the other connector end interface.

7. The connector of claim 6, wherein the diaphragm is configured to move in a direction that opposes the direction of the interior space when not engaged by the protrusion.

8. The connector of claim 1, wherein the interior space is a first interior space, the piezochromic material is first piezochromic material, the window is a first window, and the moveable components is a first moveable component,
wherein the connector end defines a second interior space for containing second piezochromic material,
wherein the connector further comprises:
a second window integrated into the connector end to provide view from outside of the connector end to the second interior space; and
a second moveable component integrated with the connector end and moveable, by interface of the connector end with the other connector end, in a direction to decrease a volume of the second interior space for compressing the second piezochromic material contained in the second interior space such that the second piezochromic material changes color for indicating interface of the connector end with the other connector end.

9. The connector of claim 8, wherein the connector end defines a first side and a second side, wherein the first window and the first interior space are positioned integrated with the first side, and wherein the second window and the second interior space are positioned integrated with the second side.

10. A method for indicating interface of connector ends, the method comprising:
providing a connector comprising:
a connector end that defines an interior space for containing a piezochromic material, the connector end being configured to interface with another connector end;
a window integrated into the connector end to provide view from outside of the connector end to the interior space; and
a moveable component integrated with the connector end and moveable by interface of the connector end with the other connector end; and
moving the moveable component in a direction to decrease a volume of the interior space for compressing the piezochromic material contained in the interior space such that the piezochromic material changes color for indicating interface of the connector end with the other connector end.

11. The method of claim 10, wherein the connector end is a connector end of an electrical cable.

12. The method of claim 10, wherein the piezochromic material includes one of piezochromic ink, piezochromic liquid, or piezochromic plastic.

13. The method of claim 10, wherein moving the moveable component comprises moving a protrusion defined by the other connector end for moving the moveable component in the direction to decrease the volume of the interior space when the connector end and/or the other connector end are moved to a position such that the connector end and the other connector end interface.

14. The method of claim 10, wherein the moveable component is a flexible diaphragm, and
wherein moving the moveable component comprises deflecting the moveable component in the direction of the interior space to decrease the volume of the interior space for compressing the piezochromic material.

15. The method of claim 14, wherein the other connector end defines a protrusion, and
wherein moving the moveable component causes the protrusion to engage and push the flexible diaphragm to deflect in the direction of the interior space when the connector end and/or the other connector end are moved to a position such that the connector end and the other connector end interface.

16. The method of claim 15, wherein the diaphragm is configured to move in a direction that opposes the direction of the interior space when not engaged by the protrusion.

17. The method of claim 10, wherein the interior space is a first interior space, the piezochromic material is first piezochromic material, the window is a first window, and the moveable components is a first moveable component,
wherein the connector end defines a second interior space for containing second piezochromic material,
wherein the connector further comprises:
a second window integrated into the connector end to provide view from outside of the connector end to the second interior space; and
a second moveable component integrated with the connector end and moveable, by interface of the connector end with the other connector end, in a direction to decrease a volume of the second interior space for compressing the second piezochromic material contained in the second interior space such that the second piezochromic material changes color for indicating interface of the connector end with the other connector end.

18. The method of claim 17, wherein the connector end defines a first side and a second side, wherein the first window and the first interior space are positioned integrated with the first side, and wherein the second window and the second interior space are positioned integrated with the second side.

19. A connector comprising:
a connector end that defines passageway that extends between a first opening and a second opening;
a covering that at least partially covers the first opening;
an interface side that is configured to interface with another connector end having a protrusion, wherein the second opening is position on the interface side, and wherein the protrusion extends through the second opening, through the passageway, and through the second opening such that the covering is moved for view of the protrusion for indicating interface of the connector end with the other connector end.

20. The connector of claim 19, wherein the covering comprises a flexible material attached on one side to the connector end.
